(19) United States
(12) Patent Application Publication
(10) Pub. No.: US 2024/0166254 A1
(43) Pub. Date: May 23, 2024

(54) FASTENING UNIT, ARMREST MECHANISM AND HANDCART

(71) Applicant: WONDERLAND SWITZERLAND AG, Steinhausen (CH)

(72) Inventor: Xiaojian ZHANG, Dongguan (CN)

(21) Appl. No.: 18/513,063

(22) Filed: Nov. 17, 2023

(30) Foreign Application Priority Data
Nov. 18, 2022 (CN) 202211448894.1

(51) Int. Cl. B62B 9/24

(52) U.S. Cl. CPC B62B 9/245

(57) ABSTRACT

The present disclosure discloses a fastening unit, an armrest mechanism and a handcart. The handcart includes an armrest mechanism including a fastening unit. The fastening unit includes: a fastening base including a first fastening part and connected to a first object; and a fastening assembly movably connected to the fastening base, and including a second fastening part. The fastening assembly has a locked position and an unlocked position. When the fastening assembly is in the locked position, the first fastening part is fastened to the second fastening part, and the fastening assembly and the fastening base encloses an accommodating space configured to accommodate a second object. When the fastening assembly is in the unlocked position, the first fastening part and the second fastening part are unfastened from each other, and the second object is capable of being separated from the fastening unit.

### CROSS-REFERENCE TO RELATED APPLICATIONS

This application claims priority to China Patent Application No. 202211448894.1, filed on Nov. 18, 2022, the content of which is hereby incorporated by reference in its entirety.

### TECHNICAL FIELD

The present disclosure relates to the technical field of handcarts, and in particular, to a fastening unit, an armrest mechanism, and a handcart.

### BACKGROUND

A handcart such as baby carrier or nursing carrier is usually designed with an armrest mechanism in front of the handcart for the safety of an occupant, in order to prevent the occupant from sliding forward and falling off. During use, the armrest can be opened or closed, to facilitate the use by the occupant. However, the conventional armrest mechanism has a relatively complicate detachable structure.

### SUMMARY

Accordingly, it is necessary to provide a fastening unit, an armrest mechanism and a handcart, which can disassemble and assemble an armrest through a simple structure.

The present disclosure provides a fastening unit, including: a fastening base including a first fastening part, and connected to a first object; and a fastening assembly movably connected to the fastening base, and including a second fastening part. The fastening assembly has a locked position and an unlocked position. When the fastening assembly is in the locked position, the first fastening part is fastened to the second fastening part, and the fastening assembly and the fastening base encloses an accommodating space configured to accommodate a second object. When the fastening assembly is in the unlocked position, the first fastening part and the second fastening part are unfastened from each other, and the second object is capable of being separated from the fastening unit.

In the above fastening unit, the first object may be the armrest body, and the second object may be the frame of the handcart. The fastening assembly may removably connect the armrest body to the frame of the handcart simply and quickly. Specifically, when it is necessary to mount the armrest body on the frame of the handcart, the armrest body can be connected to the fastening base, and the fastening assembly is positioned in the locked position. In this case, the first fastening part is fastened to the second fastening part, and the fastening assembly and the fastening base enclose an accommodating space that can accommodate the frame of the handcart, thereby connecting the armrest body to the frame of the handcart. When it is necessary to remove the armrest body from the frame of the handcart, the fastening assembly can be positioned in the unlocked position, and in this case, the first fastening part and the second fastening part are unfastened from each other, and the frame of the handcart can be separated from the fastening unit, so that the frame of the handcart is separated from the armrest body. In this way, by means of the above-mentioned fastening unit, the armrest body can be assembled to and removed from the frame of the handcart by a simple structure and simple operations.

In an embodiment, the fastening assembly is rotatably connected to the fastening base.

In an embodiment, the fastening assembly includes a fastening handle and a fastening member. The fastening handle is pivotally connected to the fastening base through a first pivot shaft. The fastening handle is pivotally connected to the fastening member through a second pivot shaft. The first pivot shaft is spaced apart from the second pivot shaft. The fastening member is provided with the second fastening part.

In an embodiment, the first pivot shaft is parallel to the second pivot shaft.

In an embodiment, the fastening handle includes an operating part and a rotatable part that are connected to each other and arranged at an angle. The rotatable part is pivotally connected to the fastening base through the first pivot shaft. The fastening member is pivotally connected to the rotatable part through the second pivot shaft. The operating part extends in a direction away from the accommodating space.

In an embodiment, the fastening handle has a first rotation position and a second rotation position. The second fastening part is a fastening rod arranged on the fastening member. The first fastening part includes a fastening groove capable of fastening the fastening rod. The fastening groove is arranged on a surface of the first fastening part away from the accommodating space. A side of the first fastening part facing the accommodating space is assumed as a first side, and another side of the first fastening part facing away the accommodating space is assumed as a second side. When the fastening handle is in the first rotation position, the fastening rod is capable of being limited at the first side or the second side of the first fastening part. When the fastening handle is in the second rotation position, the fastening rod is not limited at the first side or the second side of the first fastening part.

In an embodiment, the fastening base is provided with a receiving groove. A groove wall of the receiving groove and the fastening member enclose the accommodating space. The receiving groove includes a first edge and a second edge facing each other at an opening of the receiving groove. The first fastening part is arranged on the first edge. The fastening assembly is pivotally connected to the second edge through a first pivot shaft.

An armrest mechanism includes an armrest body, and the fastening unit according to any one of the embodiments. The armrest body is the first object.

In an embodiment, the armrest body is rotatably connected to the fastening base.

In an embodiment, the armrest body is rotatable around the fastening base within a preset angle range.

In an embodiment, one of the armrest body and the fastening base is provided with a first groove, the other of the armrest body and the fastening base is provided with a first protrusion capable of being inserted into the first groove. The first groove includes a first groove wall and a second groove wall opposite to the first groove wall. When the armrest body and the fastening base rotate relative to each other, the first protrusion moves between the first groove wall and the second groove wall along the first groove.

In an embodiment, the fastening base includes a connecting groove. The armrest body is rotatably inserted into the connecting groove. The armrest body is removably connected to the fastening base.

In an embodiment, the fastening base includes a connecting groove, and the armrest body is rotatably inserted into the connecting groove. A groove wall of the connecting groove is provided with a first groove. The armrest body is provided with a first protrusion capable of being inserted into the first groove. The first groove includes a first groove wall and a second groove wall opposite to the first groove wall. When the armrest body and the fastening base rotate relative to each other, the first protrusion moves between the first groove wall and the second groove wall along the first groove.

In an embodiment, the first groove is an arc-shaped groove arranged on a groove wall of the connecting groove in a circumferential direction of the connecting groove.

In an embodiment, the first protrusion is movably arranged on the armrest body. The first protrusion has a first moving position and a second moving position. When the first protrusion is in the first moving position, the first protrusion protrudes from a surface of the armrest body and is capable of being inserted into the first groove. When the first protrusion is in the second moving position, the first protrusion retracts into the armrest body and separates from the first groove.

In an embodiment, the armrest mechanism further includes an elastic member arranged between the first protrusion and the armrest body. The elastic member biases the first protrusion towards the first moving position. Or, the armrest mechanism further includes an elastic member. The armrest body includes a mounting cavity and a mounting hole in communication with the mounting cavity. The first protrusion is movably arranged at the mounting hole. The elastic member is arranged in the mounting cavity. An end of the elastic member is connected to or abuts against the first protrusion, and another end of the elastic member is connected to or abuts against a wall of the mounting cavity. The elastic member biases the first protrusion towards the first moving position.

In an embodiment, the armrest body is a U-shaped rod. Two fastening units are provided. Two ends of the U-shaped rod are connected to the fastening bases of the two fastening units respectively.

A handcart includes: a frame; a fastening unit including a fastening base and a fastening assembly movably connected to the fastening base, the fastening base including a first fastening part, the fastening assembly including a second fastening part; and an armrest body connected to the fastening base. The fastening assembly has a locked position and an unlocked position. When the fastening assembly is in the locked position, the first fastening part is fastened to the second fastening part, and the fastening assembly and the fastening base encloses an accommodating space configured to accommodate at least part of the frame. When the fastening assembly is in the unlocked position, the first fastening part and the second fastening part are unfastened from each other, and the frame is capable of being separated from the fastening unit.

In an embodiment, the fastening base is provided with a first limiting portion, the frame is provided with a second limiting portion. When at least part of the frame is inserted into the accommodating space, the first limiting portion cooperates with and is locked with the second limiting portion to limit a relative rotation of the fastening unit and the frame.

In an embodiment, one of the first limiting portion and the second limiting portion is a second protrusion, the other of the first limiting portion and the second limiting portion is a second groove capable of being adapted to the second protrusion.

In an embodiment, the fastening base is provided with a receiving groove. A groove wall of the receiving groove and the fastening assembly enclose the accommodating space.

In an embodiment, the groove wall of the receiving groove is provided with the first limiting portion.

In an embodiment, the handcart further includes a pin extending through the frame. At least part of the pin protrudes from the frame to form the second protrusion. The groove wall of the receiving groove is provided with the second groove. When at least part of the frame is inserted into the accommodating space, the second protrusion is engaged into the second groove to limit a relative rotation of the fastening base and the frame.

In an embodiment, two ends of the pin protrude from the frame respectively to form two second protrusions. Two opposite second grooves are arranged on the groove wall of the receiving groove. When at least part of the frame is inserted into the accommodating space, the two second protrusions are engaged into the two second grooves respectively.

In an embodiment, the armrest body is a U-shaped rod. Two ends of the U-shaped rod are removably connected to both sides of the frame through two fastening units respectively. The frame includes two connecting rods. The two ends of the U-shaped rod are removably connected to the two connecting rods through the two fastening units respectively.

### BRIEF DESCRIPTION OF THE DRAWINGS

FIG. 1 is a perspective schematic view of a handcart according to an embodiment of the present disclosure, with both ends of an armrest body being mounted on a frame.

FIG. 2 is a perspective schematic view showing the armrest body of the handcart shown in FIG. 1, with an end of the armrest body being separated from the frame.

FIG. 3 is a perspective schematic view showing the armrest body of the handcart shown in FIG. 1, with both ends of the armrest body being separated from the frame.

FIG. 4 is a perspective schematic view of an armrest mechanism of the handcart shown in FIG. 1.

FIG. 5 is an enlarged view of portion A in FIG. 4, with a fastening assembly being in an unlocked position.

FIG. 6 is another enlarged view of the portion A in FIG. 4, with the fastening assembly being in a locked position.

FIG. 7 is yet another enlarged view of the portion A in FIG. 4 from another perspective different than FIG. 5, with the fastening assembly being in the unlocked position.

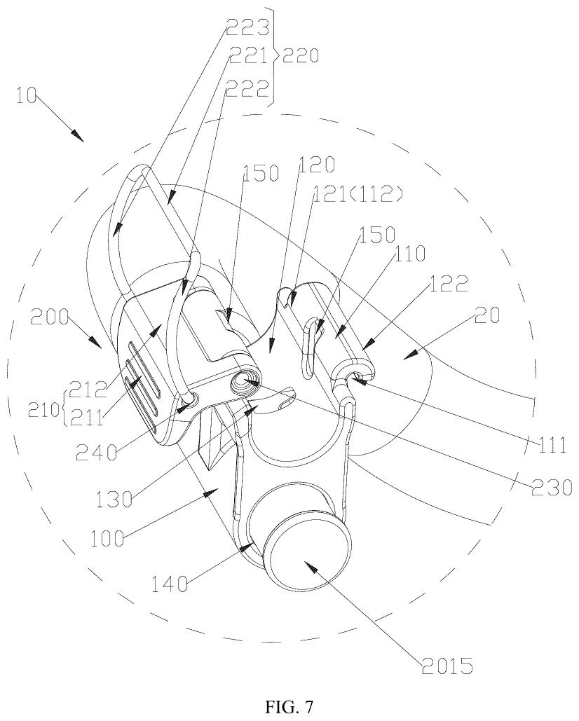

FIG. 8 is an exploded view of the portion A in FIG. 4.

FIG. 9 is a cross-sectional view taken along a line B-B in FIG. 1, with the fastening assembly is in the locked position.

FIG. 10 is a perspective schematic view of a structure shown in FIG. 9 in which the fastening assembly is switched to the unlocked position and a connecting rod is omitted.

### ILLUSTRAATION FOR REFERENCE SIGNS

10, Fastening unit; 100, Fastening base; 110, First fastening part; 111, Fastening groove; 112, Third edge; 113, Fourth edge; 120, Receiving groove; 121, First edge; 122, Second edge; 130, First groove; 131, First groove wall; 132, Second groove wall; 140, Connecting groove; 141, Sidewall; 150, Second groove; 200, Fastening assembly; 210, Fastening handle; 211, Operation part; 212, Rotatable part; 220, Fastening member; 221, Second fastening part/Fastening rod; 222, First rod; 223, Second rod; 230, First pivot shaft; 240, Second pivot shaft; 300, Accommodating space; 20, Armrest body; 2011, First protrusion; 2012, Mounting cavity; 2013, Mounting hole; 2014, Elastic member; 2015, Connecting part, 30, Frame; 3010, Connecting rod; 3020, Second protrusion; 3030, Pin; 3040, Seat assembly, 3050, Push handle assembly.

### DETAILED DESCRIPTION OF THE EMBODIMENTS

In order to make the object, technical solution and advantages of the present disclosure clearer, the present disclosure will be further described in detail below in conjunction with the accompanying drawings and specific embodiments. It should be understood that the specific embodiments described herein are only used to illustrate the present disclosure, and do not limit the protection scope of the present disclosure.

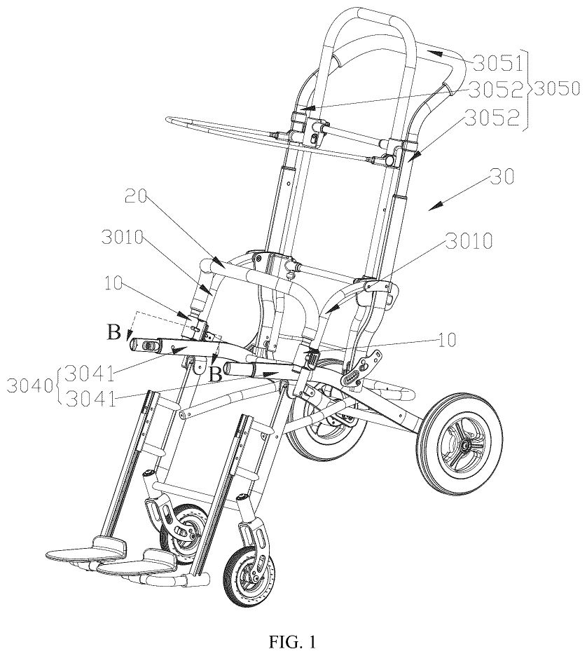

As shown in FIG. 1, an embodiment of the present disclosure provides a handcart, which can be a nursing carrier for patients or the elderly, or a stroller for child to sit on. The handcart can detach and assemble an armrest more conveniently through a simple structure.

Specifically, the handcart includes a frame 30 and an armrest mechanism. The frame 30 includes a seat assembly 3040, a push handle assembly 3050, and a connecting rod 3010. The seat assembly 3040 includes two seat support rods 3041 arranged to be opposite to each other. The push handle assembly 3050 has a U-shaped structure as a whole, and includes a handle body 3051 and two handle support rods 3052 connected to both ends of the handle body 3051. The two handle support rods 3052 are respectively connected to the relative rear ends of the two seat support rods 3041. The connecting rods 3010 are roughly arc-shaped. The two connecting rods 3010 are respectively connected to the two handle support rods 3052 at one end, and are respectively connected to the relative front ends of the two seat support rods 3041 at another end. In this way, the handle support rod 3052, the seat support rod 3041, and the connecting rod 3010 on each side form a stable triangular support structure, thereby ensuring the stability of the overall frame 30. In other embodiments, the connecting rod 3010 may also be a straight rod, a L-shaped rod, etc. In this embodiment, the connecting rod 3010 is a hollow rod. In other embodiments, the connecting rod 3010 may also be a solid rod.

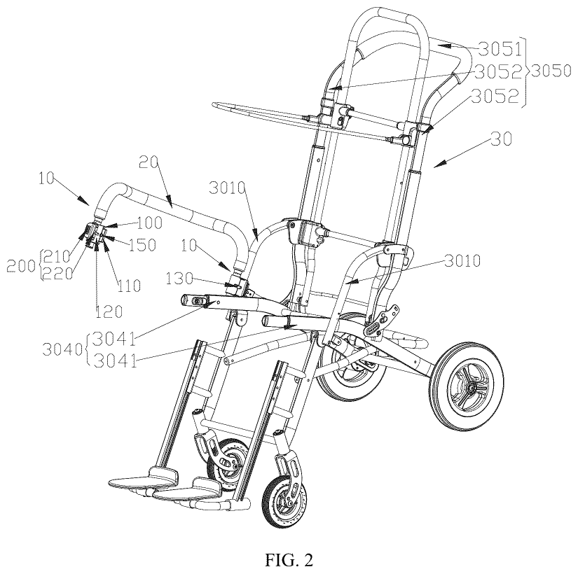

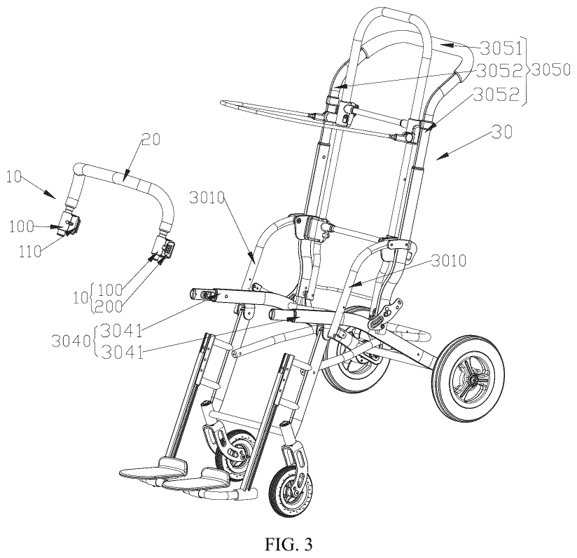

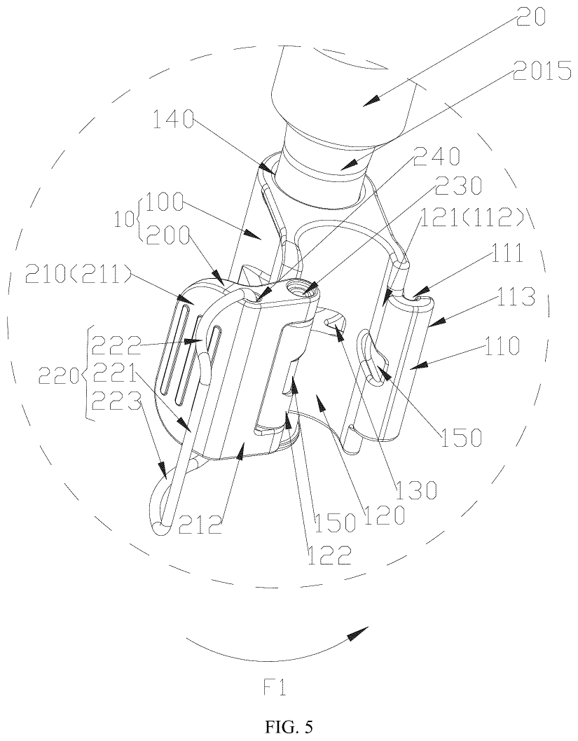

Specifically, the armrest mechanism includes a fastening unit 10 and an armrest body 20. The armrest body 20 is rotatably connected to the fastening unit 10. The armrest body 20 can be removably connected to the connecting rod 3010 through the fastening unit 10. In this embodiment, the armrest body 20 is a U-shaped rod. Two ends of the U-shaped rod serve as connecting parts 2015 (see FIG. 5), which are removably connected to the two connecting rods 3010 through two fastening units 10 respectively. In this way, as shown in FIG. 1, when the two connecting parts 2015 of the armrest body 20 are connected to the two connecting rods 3010 through the two fastening units 10 respectively, the armrest body 20, the seat assembly 3040, the push handle assembly 3050, and the connecting rods 3010 enclose a seating space. The armrest body 20 can be used to block the occupant to prevent the occupant from sliding forward and falling off, so as to improve the seating safety of the handcart. As shown in FIG. 2, any one of the connecting parts 2015 of the armrest body 20 can also be removed and separated from the connecting rod 3010 on the corresponding one of two sides, and the other of the connecting parts 2015 of the armrest body 20 can be rotated relative to the connecting rod 3010 on the other of the two sides through the fastening unit 10, so that the armrest body 20 rotates to the one side of the frame 30, thereby making it convenient for the occupant to sit on the handcart or move out from the handcart. As shown in FIG. 3, when the armrest is not needed, the two connecting parts 2015 of the armrest body 20 can also be removed and separated from the connecting rods 3010 on the two sides.

The configurations and connection modes of the fastening units 10 are described in detail below by taking one of the fastening units 10 as an example.

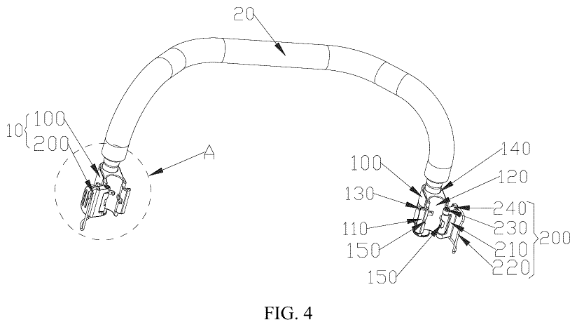

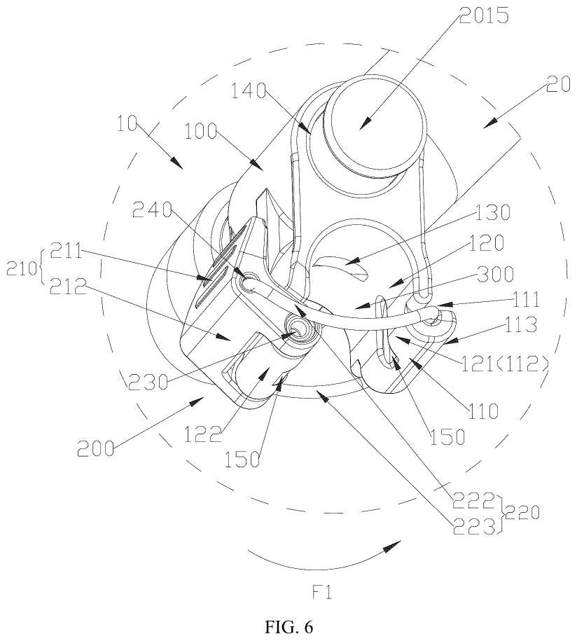

Specifically, as shown in FIGS. 4 and 5, the fastening unit 10 includes a fastening base 100 and a fastening assembly 200. The fastening assembly 200 is movably connected to the fastening base 100. The fastening base 100 includes a first fastening part 110, and the fastening assembly 200 includes a second fastening part 221. The fastening assembly 200 has a locked position and an unlocked position. As shown in FIG. 6, when the fastening assembly 200 is in the locked position, the first fastening part 110 is fastened to the second fastening part 221. The fastening assembly 200 and the fastening base 100 encloses an accommodating space 300 configured to accommodate the connecting rod 3010. As shown in FIG. 5, when the fastening assembly 200 is in the unlocked position, the first fastening part 110 and the second fastening part 221 are unfastened from each other, and the connecting rod 3010 can be separated from the fastening unit 10.

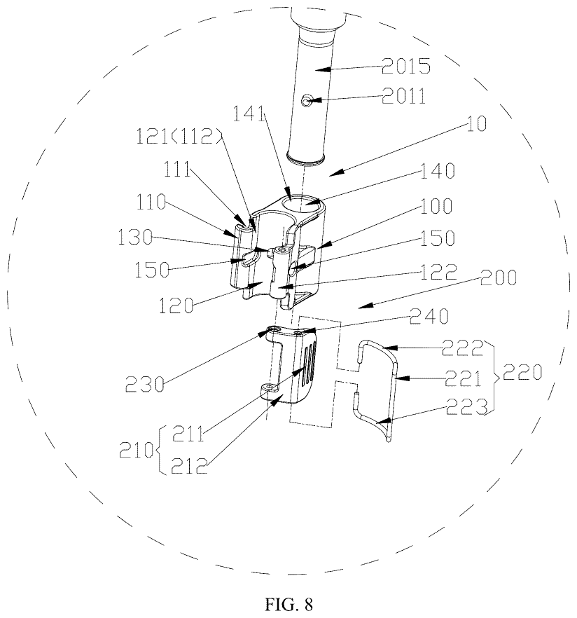

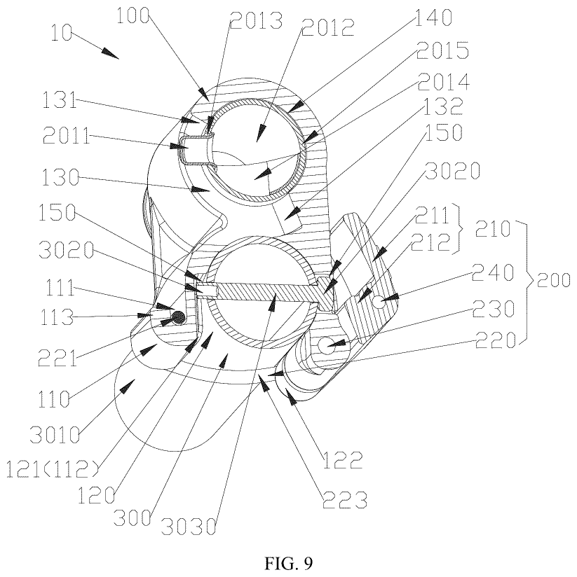

Specifically, as shown in FIGS. 8 and 9, the fastening base 100 includes a connecting groove 140. In this embodiment, the connecting groove 140 is a cylindrical groove, and the connecting groove 140 is shaped and sized to match the connecting part 2015 of the armrest body 20. The connecting part 2015 of the armrest body 20 can be inserted into the connecting groove 140 and can rotate relative to a groove wall of the connecting groove 140. Furthermore, a groove wall of the connecting groove 140 is also provided with a first groove 130 arranged in a circumferential direction. The first groove 130 is an arc-shaped groove. A center of the arc-shaped groove is located on a central axis of the connecting groove 140. Both ends of the first groove 130 includes a first groove wall 131 and a second groove wall 132 respectively. The connecting part 2015 of the armrest body 20 is provided with a first protrusion 2011. When the connecting part 2015 is inserted into the connecting groove 140, the first protrusion 2011 is inserted into the arc-shaped groove, and can move between the first groove wall 131 and the second groove wall 132, thereby limiting a rotation angle of the armrest body 20 relative to the fastening unit 10, and in turn, limiting a rotation angle of the armrest body 20 relative to the connecting rod 3010 to prevent excessive rotation of the armrest body 20.

Further, as shown in FIG. 9, the first protrusion 2011 is movably arranged on the armrest body 20. The first protrusion 2011 has a first moving position and a second moving position. When the first protrusion 2011 is in the first moving position (As shown in FIG. 9), the first protrusion 2011 protrudes from a surface of the armrest body 20 and can be inserted into the first groove 130. When the first protrusion 2011 is in the second moving position (which is not shown in the figures), the first protrusion 2011 retracts into the armrest body 20 and separates from the first groove 130.

Specifically, the armrest body 20 is a hollow rod. A mounting cavity 2012 is formed in a hollow cavity of the hollow rod. In other embodiments, the armrest body 20 may also only be provided with the mounting cavity 2012 at a portion close to the connecting part 2015. The connecting part 2015 is further provided with a mounting hole 2013 in communication with the mounting cavity 2012. The first protrusion 2011 is movably arranged at the mounting hole 2013. An elastic member 2014 is arranged in the mounting cavity 2012. An end of the elastic member 2014 is connected to or abuts against the first protrusion 2011, and another end of the elastic member 2014 is connected to or abuts against a wall of the mounting cavity 2012. In this way, the elastic member 2014 biases the first protrusion 2011 towards the first moving position. In this embodiment, the elastic member 2014 is an elastic piece. In other embodiments, the elastic member 2014 may also be a spring or other elastic structure.

As such, when the connecting part 2015 of the armrest body 20 is inserted into the connecting groove 140 through an opening of the connecting groove 140, the first protrusion 2011 is first moved to the second moving position, pushed and pressed by a sidewall 141 (see FIG. 8) of the connecting groove 140. That is, the first protrusion 2011 retracts into the mounting cavity 2012 instead of protruding from the surface of the connecting part 2015, so that the connecting part 2015 can be smoothly inserted into the connecting groove 140. When the connecting part 2015 is properly inserted into the connecting groove 140, the first protrusion 2011 just faces the first groove 130. In this case, the first protrusion 2011, which is not being pushed and pressed by the sidewall 141 of the connecting groove 140, is moved to the first moving position under the action of the elastic member 2014. That is, the first protrusion 2011 protrudes from the mounting cavity 2012 and protrudes from the surface of the connecting part 2015, and is inserted into the first groove 130. In this way, the armrest body 20 and the fastening unit 10 can be mounted together.

In other embodiments, a first limiting portion such as the first groove 130 may also be arranged on the connecting part 2015 of the armrest body 20, and a second limiting portion such as the first protrusion 2011 may be arranged on the fastening base 100. In short, it is sufficient to realize the rotatable connection between the connecting part 2015 of the armrest body 20 and the fastening base 100 while restricting the relative rotation angle between the connecting part 2015 of the armrest body 20 and the fastening base 100. In addition, without considering facilitating mounting the armrest body 20 and the fastening unit 10, for example, if the armrest body 20 and the fastening base 100 are directly made by integral casting or injection molding, then the first protrusion 2011 can also be directly fixed to the connecting part 2015 without providing the elastic member 2014.

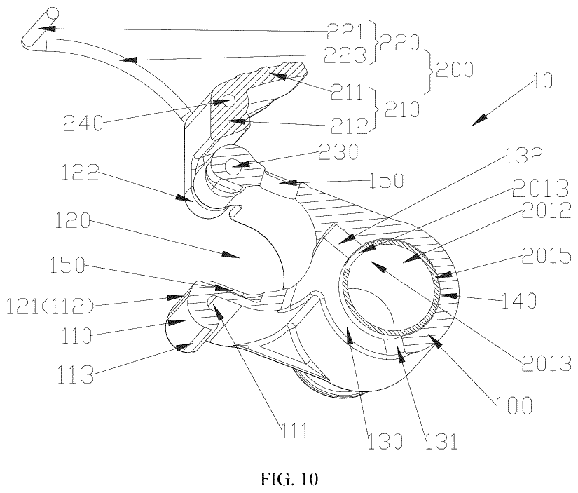

Further, as shown in FIGS. 9 and 10, the fastening base 100 is further provided with a receiving groove 120. In this embodiment, the receiving groove 120 is a semi-cylindrical groove whose extending direction is substantially parallel to the axial direction of the connecting groove 140. A plane where an opening of the receiving groove is located is substantially perpendicular to a plane where an opening of the connecting groove is located. In other embodiments, the extending direction of the receiving groove 120 and the axial direction of the connecting groove 140 may not be parallel to each other, but may be arranged at an angle. Alternatively, the angle between the plane where the opening of the receiving groove is located and the plane where the opening of the connecting groove is located can also be greater than 90 degrees or less than 90 degrees. The receiving groove 120 extends through both ends of the fastening base 100 in its extending direction. The receiving groove 120 includes a first edge 121 and a second edge 122 facing each other at an opening thereof. In this embodiment, both the first edge 121 and the second edge 122 are substantially parallel to the axial direction of the connecting groove 140. The first fastening part 110 is arranged at the first edge 121. In this embodiment, the first fastening part 110 is a fastening boss fixed on the first edge 121. The fastening boss includes a fastening groove 111. The fastening groove 111 is arranged on a surface of the first fastening part 110 away from the accommodating space 300. An opening of the fastening groove 111 and the opening of the receiving groove 120 face opposite directions. A side of the first fastening part 110 facing the opening of the receiving groove 120 (or facing the accommodating space 300) is assumed as a first side, and another side of the first fastening part 110 facing away from the opening of the receiving groove 120 (or facing away from the accommodating space 300) is assumed as a second side. That is, the fastening groove 111 is located on the second side of the fastening part 110. The first fastening part 110 includes a third edge 112 and a fourth edge 113 that are opposite to each other. The third edge 112 and the first edge 121 are the same edge, and the fourth edge 113 is substantially parallel to the first edge 121. In this embodiment, a surface of the first fastening part 110 between the third edge 112 and the fourth edge 113 is a circular arc transition surface, which is beneficial to guide the second fastening part 221 to be fastened to the fastening groove 111.

Specifically, as shown in FIGS. 5 and 6, the fastening assembly 200 includes a fastening handle 210 and a fastening member 220. The fastening handle 210 includes an operating part 211 and a rotatable part 212 that are connected to each other and arranged at an angle. In this embodiment, the operating part 211 and the rotatable part 212 are arranged at an obtuse angle. In other embodiments, the operating part 211 and the rotatable part 212 may also be arranged at a right angle or an acute angle. In this embodiment, the fastening handle 210 is integrally formed. In other embodiments, the fastening handle 210 may also be formed by connecting the operation part 211 and the rotatable part 212 that are independent of each other through welding, riveting, welding etc. Both the operating part 211 and the rotatable part 212 are substantially plate-shaped. A side of the rotatable part 212 is fixedly connected to a side of the operating part 211, and another side of the rotatable part 212 is pivotally connected to the second edge 122 of the fastening base 100 through a first pivot shaft 230. A second pivot shaft 240 is arranged at the connection of the operating part 211 and the rotatable part 212. The first pivot shaft 230 is spaced apart from the second pivot shaft 240. The first pivot shaft 230 is substantially parallel to the second pivot shaft 240. The operating part 211 extends in a direction away from the accommodating space 300.

In an embodiment, the fastening member is a U-shaped rod. The U-shaped rod includes a fastening rod, a first rod, and a second rod. The first rod and the second rod are respectively connected to two ends of the fastening rod, and are respectively arranged at an angle with the fastening rod. Ends of the first rod and the second rod away from the fastening rod are pivotally connected to the fastening handle through the second pivot shaft respectively. The fastening rod forms the second fastening part. The first fastening part includes a fastening groove capable of fastening the fastening rod.

Further, as shown in FIGS. 5 and 6, the fastening member 220 is a U-shaped rod with a certain elastic deformation capability. The U-shaped rod includes a fastening rod 221, a first rod 222, and a second rod 223. The first rod 222 and the second rod 223 are respectively connected to two ends of the fastening rod 221, and are respectively arranged at an angle with the fastening rod 221. Ends of the first rod 222 and the second rod 223 away from the fastening rod 221 are pivotally connected to the fastening handle 210 through the second pivot shaft 240 respectively. In this way, the fastening rod 221 forms a second fastening part 221. The fastening rod 221 can be fastened to the fastening groove 111 of the first fastening part 110, so that the fastening handle 210, the fastening member 220, and a groove wall of the receiving groove 120 enclose the accommodating space into which the connecting rod 3010 can be inserted. In this embodiment, the accommodating space 300 is shaped and sized to be adapted to the shape and size of a portion of the connecting rod 3010 inserted into the accommodating space 300, so that the connection between the fastening unit 10 and the connecting rod 3010 can be more stable and not easy to shake. In this embodiment, the connecting rod 3010 is a round rod, and the accommodating space 300 is a cylindrical space adapted to the round rod.

Further, the fastening handle 210 has a first rotation position and a second rotation position. When the fastening handle 210 is in the first rotation position, a straight-line distance between the second pivot shaft 240 and the fourth edge 113 is longer. In this case, if the fastening rod 221 is located on the first side of the first fastening part 110, as shown in FIG. 5, the fastening rod 221 cannot pass over the fourth edge 113 and rotate to the second side of the first fastening portion 110. If the fastening rod 221 is located on the second side of the first fastening part 110, as shown in FIG. 6, the fastening rod 221 cannot pass over the fourth edge 113 and rotate to the first side of the first fastening portion 110. In this way, the fastening rod 221 can be limited to the second side of the first fastening part 110, and the fastening rod 221 can be fastened to the fastening groove 111, thereby ensuring the fastening tightness between the fastening rod 221 and the fastening groove 111, so that the fastening unit 10 is not easy to fall off from the connecting rod 3010. When the fastening handle 210 is in the second rotation position (not shown in the figure), a straight-line distance between the second pivot shaft 240 and the fourth edge 113 is relatively short. In this case, when the fastening member 220 rotates around the second pivot shaft 240, the fastening member 220 can rotate from the first side of the first fastening part 110 to the second side of the first fastening part 110 with passing over the fourth edge 113, or can rotate from the second side of the first fastening part 110 to the first side of the first fastening part 110 with passing over the fourth edge 113, and the fastening rod 221 and the fastening groove 111 are in an unfastened state.

Further, as shown in FIG. 9, a pin 3030 extends through the connecting rod 3010 in a radial direction of the connecting rod 3010. Two opposite ends of the pin 3030 protrude from the connecting rod 3010 respectively to form two second protrusions 3020. Two opposite second grooves 150 are arranged on a groove wall of the receiving groove 120. When the connecting rod 3010 is inserted into in the accommodating space 300, the two second protrusions 3020 can be engaged into the two second grooves 150 respectively. In this way, the relative rotation of the fastening unit 10 and the connecting rod 3010 can be prevented, and the fastening unit 10 can be prevented from moving in the extending direction of the connecting rod 3010. That is, when the connecting rod 3010 is inserted into the accommodating space 300, the connecting rod 3010 is relatively fixed to the fastening unit 10, so that when one end of the armrest body 20 is unfastened from the connecting rod 3010 on the corresponding side, the armrest body 20 can rotate around the fastening base 100 within a preset angle range, that is, the armrest body 20 can rotate around the connecting rod 3010 within a preset angle range.

In other embodiments, the second protrusion 3020 may not be formed by both ends of the pin 3030, and the second protrusion 3020 may be a protrusion directly protruding from the surface of the connecting rod 3010. Alternatively, the arrangement may be reversed, the first limiting portion such as the second protrusion 3020 is arranged on the fastening base 100, and the second limiting portion such as the second groove 150 is arranged on the connecting rod 3010, so that the fastening base 100 and the connecting rod 3010 can be fixed and limited.

The processes of fastening and unfastening between the fastening unit 10 and the connecting rod 3010 will be described in detail below.

When it is necessary to connect the end of the armrest body 20 to the connecting rod 3010, as shown in FIG. 5, the fastening base 100 at the end of the armrest body 20 is engaged to the connecting rod 3010, so that at least part of the connecting rod 3010 is inserted into the receiving groove 120 through the opening of the receiving groove 120, and the second protrusions 3020 at both ends of the pin 3030 are respectively engaged into the two second grooves 150 on the groove wall of the receiving groove 120. Then, the fastening assembly 200 can be rotated in the direction F1 shown in FIG. 5, so that the fastening rod 221 passes over the fourth edge 113 and is fastened to the fastening groove 111 of the first fastening part 110. Then, the operating part 211 can be rotated in a direction opposite to the direction F1, so that the fastening handle 210 rotates around the first pivot shaft 230 to the first rotation position as shown in FIG. 6, and then, the fastening rod 221 is tightened and limited in the fastening groove 111, and cannot rotate relative to the second pivot shaft 240 to pass over the fourth edge 113. In this way, the armrest body 20 is fixedly connected to the connecting rod 3010.

When it is necessary to remove the end of the armrest body 20 from the connecting rod 3010, an external force can be applied to the operating part 211 to make the fastening handle 210 rotate around the first pivot shaft 230 in the direction F1 to the second rotation position. In this case, the second pivot shaft 240 moves with the fastening handle 210 towards the first fastening part 110 until the fastening rod 221 can pass over the fourth edge 113 and separates from the fastening groove 11. That is, the first fastening part 110 and the second fastening part 221 are unfastened from each other. The connecting rod 3010 can move out of the receiving groove 120 through the opening of the receiving groove 120, as shown in FIG. 5.

In other embodiments, the above-mentioned fastening unit 10 may not be used to fasten the armrest body 20 and the connecting rod 3010, and the fastening unit 10 may also be a rod-shaped component used for fastening connection, for example, may be used to fasten the armrest body 20 and the handle support rod 3052, or fasten the handle support rod 3052 and an armrest support rod, and which is not limited in the present disclosure.

The above-mentioned fastening unit 10, the armrest mechanism, and the handcart have at least the following technical effects.

In the above-mentioned fastening unit 10, the armrest body 20 may be configured as a first object connected to the fastening unit 10, and the frame 30 of the handcart may be configured as a second object connected to the fastening unit 10. The fastening assembly 200 may removably connect the armrest body 20 to the frame 30 of the handcart simply and quickly. Specifically, when it is necessary to mount the armrest body 20 on the frame 30 of the handcart, the armrest body 20 can be connected to the fastening base 100, and the fastening assembly 200 is positioned in the locked position. In this case, the first fastening part 110 is fastened to the second fastening part 221, and the fastening assembly 200 and the fastening base 100 enclose an accommodating space 300 that can accommodate the frame 30 of the handcart, thereby connecting the armrest body 20 to the frame 30 of the handcart. When it is necessary to remove the armrest body 20 from the frame 30 of the handcart, the fastening assembly 200 can be positioned in the unlocked position, and in this case, the first fastening part 110 and the second fastening part 221 are unfastened from each other, and the frame 30 of the handcart can be separated from the fastening unit 10, so that the frame 30 of the handcart is separated from the armrest body 20. In this way, by means of the above-mentioned fastening unit 10, the armrest body 20 can be assembled to and removed from the frame 30 of the handcart by a simple structure and simple operations.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variants and improvements without departing from the concept of the present disclosure, and the variations and improvements falls in the protection scope of the present disclosure. Therefore, the protection scope of the present disclosure shall be subject to the appended claims.

What is claimed is:

1. A fastening unit, comprising:
a fastening base comprising a first fastening part, and connected to a first object; and
a fastening assembly movably connected to the fastening base, and comprising a second fastening part,
wherein the fastening assembly has a locked position and an unlocked position;
wherein when the fastening assembly is in the locked position, the first fastening part is fastened to the second fastening part, and the fastening assembly and the fastening base encloses an accommodating space configured to accommodate a second object; and
wherein when the fastening assembly is in the unlocked position, the first fastening part and the second fastening part are unfastened from each other, and the second object is capable of being separated from the fastening unit.

2. The fastening unit according to claim 1, wherein the fastening assembly is rotatably connected to the fastening base.

3. The fastening unit according to claim 1, wherein the fastening assembly comprises a fastening handle and a fastening member; and
wherein the fastening handle is pivotally connected to the fastening base through a first pivot shaft, the fastening handle is pivotally connected to the fastening member through a second pivot shaft, the first pivot shaft is spaced apart from the second pivot shaft, and the fastening member is provided with the second fastening part.

4. The fastening unit according to claim 3, wherein the first pivot shaft is parallel to the second pivot shaft.

5. The fastening unit according to claim 3, wherein: the fastening handle comprises an
operating part and a rotatable part that are connected to each other and arranged at an angle;
the rotatable part is pivotally connected to the fastening base through the first pivot shaft;
the fastening member is pivotally connected to the rotatable part through the second pivot shaft; and the operating part extends in a direction away from the accommodating space.

6. The fastening unit according to claim 3, wherein the fastening handle has a first rotation position and a second rotation position, the second fastening part is a fastening rod arranged on the fastening member, the first fastening part comprises a fastening groove capable of fastening the fastening rod, and the fastening groove is arranged on a surface of the first fastening part away from the accommodating space;
wherein a side of the first fastening part facing the accommodating space is assumed as a first side, and another side of the first fastening part facing away the accommodating space is assumed as a second side; and
wherein when the fastening handle is in the first rotation position, the fastening rod is capable of being limited at the first side or the second side of the first fastening part, and when the fastening handle is in the second rotation position, the fastening rod is not limited at the first side or the second side of the first fastening part.

7. The fastening unit according to claim 1, wherein the fastening base is provided with a receiving groove; and wherein a groove wall of the receiving groove and the fastening member enclose the accommodating space; and
the receiving groove comprises a first edge and a second edge facing each other at an opening of the receiving groove; the first fastening part is arranged on the first edge; and
the fastening assembly is pivotally connected to the second edge through a first pivot shaft.

8. An armrest mechanism, comprising:
an armrest body; and
the fastening unit according to claim 1,
wherein the armrest body is the first object.

9. The armrest mechanism according claim 8, wherein the armrest body is rotatably connected to the fastening base.

10. The armrest mechanism according claim 9, wherein the armrest body is rotatable around the fastening base within a preset angle range.

11. The armrest mechanism according claim 9, wherein one of the armrest body and the fastening base is provided with a first groove, the other of the armrest body and the fastening base is provided with a first protrusion capable of being inserted into the first groove; and
wherein the first groove comprises a first groove wall and a second groove wall opposite to the first groove wall, and when the armrest body and the fastening base rotate relative to each other, the first protrusion moves between the first groove wall and the second groove wall along the first groove.

12. The armrest mechanism according claim 8, wherein the fastening base comprises a connecting groove, and the armrest body is rotatably inserted into the connecting groove, and the armrest body is removably connected to the fastening base.

13. The armrest mechanism according claim 10, wherein the fastening base comprises a
connecting groove, and the armrest body is rotatably inserted into the connecting groove; and
a groove wall of the connecting groove is provided with a first groove, and the armrest body is provided with a first protrusion capable of being inserted into the first groove; and
wherein the first groove comprises a first groove wall and a second groove wall opposite to the first groove wall, and when the armrest body and the fastening base rotate relative to each other, the first protrusion moves between the first groove wall and the second groove wall along the first groove.

14. The armrest mechanism according claim 13, wherein the first groove is an arc-shaped groove arranged on a groove wall of the connecting groove in a circumferential direction of the connecting groove.

15. The armrest mechanism according claim 13, wherein: the first protrusion is movably arranged on the armrest body; the first protrusion has a first moving position and a second moving position; when the first protrusion is in the first moving position, the first protrusion protrudes from a surface of the armrest body and is capable of being inserted into the first groove; and when the first protrusion is in the second moving position, the first protrusion retracts into the armrest body and separates from the first groove.

16. The armrest mechanism according claim 15, further comprising an elastic member arranged between the first protrusion and the armrest body, wherein the elastic member biases the first protrusion towards the first moving position; or
further comprising an elastic member,
wherein the armrest body comprises a mounting cavity and a mounting hole in communication with the mounting cavity; the first protrusion is movably arranged at the mounting hole; the elastic member is arranged in the mounting cavity; an end of the elastic member is connected to or abuts against the first protrusion, and another end of the elastic member is connected to or abuts against a wall of the mounting cavity; and the elastic member biases the first protrusion towards the first moving position.

17. The armrest mechanism according claim 8, wherein: the armrest body is a U-shaped rod; two fastening units are provided; and two ends of the U-shaped rod are connected to the fastening bases of the two fastening units respectively.

18. A handcart, comprising:
a frame;
a fastening unit comprising a fastening base and a fastening assembly movably connected to the fastening base, the fastening base comprising a first fastening part, the fastening assembly comprising a second fastening part; and
an armrest body connected to the fastening base;
wherein the fastening assembly has a locked position and an unlocked position;
wherein when the fastening assembly is in the locked position, the first fastening part is fastened to the second fastening part, and the fastening assembly and the fastening base encloses an accommodating space configured to accommodate at least part of the frame; and
wherein when the fastening assembly is in the unlocked position, the first fastening part and the second fastening part are unfastened from each other, and the frame is capable of being separated from the fastening unit.

19. The handcart according claim 18, wherein the fastening base is provided with a first limiting portion, the frame is provided with a second limiting portion; and
wherein when at least part of the frame is inserted into the accommodating space, the first limiting portion cooperates with and is locked with the second limiting portion to limit a relative rotation of the fastening unit and the frame.

20. The handcart according claim 19, wherein one of the first limiting portion and the second limiting portion is a second protrusion, and the other of the first limiting portion and the second limiting portion is a second groove capable of being adapted to the second protrusion.

21. The handcart according claim 20, wherein the fastening base is provided with a receiving groove; and wherein a groove wall of the receiving groove and the fastening assembly enclose the accommodating space.

22. The handcart according claim 21, wherein: the groove wall of the receiving groove is provided with the first limiting portion.

23. The handcart according claim 21, further comprising a pin extending through the frame,
wherein at least part of the pin protrudes from the frame to form the second protrusion;
wherein the groove wall of the receiving groove is provided with the second groove; and
wherein when at least part of the frame is inserted into the accommodating space, the second protrusion is engaged into the second groove to limit a relative rotation of the fastening base and the frame.

24. The handcart according claim 23, wherein: two ends of the pin protrude from the frame respectively to form two second protrusions; two opposite second grooves are arranged on the groove wall of the receiving groove; and when at least part of the frame is inserted into the accommodating space, the two second protrusions are engaged into the two second grooves respectively.

25. The handcart according claim 18, wherein the armrest body is a U-shaped rod, and two ends of the U-shaped rod are removably connected to both sides of the frame through two fastening units respectively; and
the frame comprises two connecting rods, and the two ends of the U-shaped rod are removably connected to the two connecting rods through the two fastening units respectively.
